(19) United States
(12) Patent Application Publication
(10) Pub. No.: US 2017/0251704 A1
(43) Pub. Date: Sep. 7, 2017

(54) FLOCCULATION

(71) Applicant: Coöperatie AVEBE U.A., Veendam (NL)

(72) Inventors: Marco Luigi Federico GIUSEPPIN, Veendam (NL); Robin Eric Jacobus SPELBRINK, Veendam (NL); Marc Christiaan LAUS, Veendam (NL); Joan SCHIPPER, Veendam (NL)

(73) Assignee: Coöperatie AVEBE U.A., Veendam (NL)

(21) Appl. No.: 15/504,094

(22) PCT Filed: Sep. 2, 2015
(86) PCT No.: PCT/NL2015/050605

§ 371 Date: Feb. 15, 2017

(30) Foreign Application Priority Data
Sep. 3, 2014 (EP) 14183425.9

(51) Int. Cl. A23L 2/82; A23L 27/21; A23L 33/175; A23L 33/12; A23L 33/15; A23K 10/35; A23L 33/105

(52) U.S. Cl. CPC A23L 2/82; A23K 10/35; A23L 27/21; A23L 33/105; A23L 33/12; A23L 33/15; A23L 33/175; A23V 2002/00

(57) ABSTRACT

A method for flocculation of root or tuber juice is described having the advantage that dissolved protein remains unaffected and that clear potato juice with an OD620 below 0.8 is obtained. This is important for applications in which soluble protein is to be extracted from root or tuber juice, because it increases lifetime of the used equipment. The method involves a) use of a coagulant comprising a cationic coagulant and a flocculant comprising an anionic polyacrylamide with a specific viscosity of 4-6 mPa·s and a charge density between 45 and 75%; or b) use of a coagulant comprising a polymeric silicate of formula SiO₃²⁻ and a flocculant comprising a cationic polyacrylamide with a specific viscosity of 3-5 mPa·s and a charge density of at most 30%; or c) use of a coagulant comprising a cationic or neutral coagulant and a flocculant comprising carrageenan. The invention further provides valuable root- or tuber derived materials, such as the floc material, a potato lipid isolate or an amino acid material.

### FIELD OF THE INVENTION

The invention pertains to a method of flocculation of root or tuber juice. The invention further pertains to clarified root or tuber juice and to floc material, obtainable by the present method. In addition, the invention pertains to a potato lipid isolate and an amino acid material, which can be obtained from the floc material.

### BACKGROUND

Solution turbidity stems from the presence of small insoluble particles in a solution, such as in a juice. These insoluble particles include (aggregates of) lipids, insoluble proteins, residual cell wall fragments, small starch granules or fragments thereof, microorganisms and soil particles. More importantly aggregates can also be derived from soluble polymers that are formed in time in the solution by enzymatic activity or by precipitation reactions of various soluble compounds and hydrocolloids. Turbidity is a problem in many industrial juices, because the insoluble particles can have detrimental effects on certain types of equipment used to manipulate these juices. Examples of such problems are the clogging of filters and membranes, film- and scale-formation on the surfaces of heat exchange devices like evaporators and cooling devices and on sensors that monitor the process such as pH meters, conductivity meters, the fouling of absorption columns resulting in increased operating pressures, and reduced effectiveness of ultraviolet light treatment.

In the case of potato juice, turbidity increases over time because of biochemical reactions that take place when the potato tuber is grated. This increased turbidity results from three distinct processes that involve different components and play out at different time-scales. First, protein species of opposite electrical charge come together in a matter of minutes into a high-density material with the approximate consistency of clay. Secondly, lipolysis in the juice liberates saturated fatty acids from the potato's lipids that precipitate with cationic protease inhibitors, forming a medium-density cloud of particles or needles over the course of several hours. Thirdly, as lipids become hydrolyzed the potato's organelles and membrane fractions adhere into a continuous oily phase of relatively low density within roughly a quarter of an hour up to several hours. The long developing times and relatively low densities of the lipid-containing flocs make these structures the most difficult to remove. The different types of turbid material can be easily visualized in the laboratory by the technique of sucrose density centrifugation where they form distinct bands of different densities.

Flocculation is a technique for removing insoluble particles, which is used for clarifying turbid solutions. In the case of potato however, it is also necessary to remove precursors of aggregates since the formation of turbid materials continues over time. In flocculation, certain (often charged) molecules adhere to insoluble particles in the juice and create aggregates. The increase in size, and the coherence of the aggregates, makes that such aggregates can be filtered, centrifuged or otherwise isolated, thereby clarifying the turbid solution. However, most flocculation materials have the tendency to denature dissolved proteins present in solution, or remove valuable proteins from the solution. This prevents the use of flocculation in cases where the juice is used to obtain native isolated proteins or is used as a basis of a potato juice concentrate or permeate. The turbidity, expressed as OD620, of untreated juice is generally between 1.2 and 2.5.

Potato juice, such as used for starch isolation, is an example of a juice rich in valuable native protein. Processes to isolate protein from potato juice have been described in WO 2008/069650. There, flocculation of the juice was achieved with a divalent metal cation, which removes negatively charged polymers, pectins, glycoalkaloids and microorganisms from the juice. However, the pretreatment does not result in a fully clarified juice, as other insoluble particles remain present. This increases cost of protein isolation, decreases lifetime of equipment used for protein isolation, and therefore entails a higher environmental burden than strictly required.

Increased concentrations of divalent cations such as calcium ions results in scaling downstream in the process. Ideally, the use of divalent ions is minimized or avoided altogether.

For many scientific studies, potato juice is clarified by ultracentrifugation at the mL scale but since such g-forces cannot be produced in equipment for industrial food production these methods are not applicable to the processing of industrial starch potato juice.

Zwijnenberg (Zwijnenberg, H. J. et al, Desalination 144 (2002) p. 331-334 Native protein recovery from potato fruit juice by ultrafiltration) describes the recovery of protein from potato juice via a membrane filtration after an unspecified flocculation treatment “to remove coagulated protein”. Zwijnenberg uses aged potato juice. While acknowledging the detrimental effect on protein, Zwijnenberg considers it unavoidable for their trials. Zwijnenberg does not mention the removal of lipids from potato juice and does not specify turbidities. The procedure resulted in a protein powder that was 53% soluble, indicating that 47% was denatured or in the form of non-resoluble aggregates.

CPC international (NL7612684A, Werkwijze voor het winnen van lipiden uit aardappelen) aims to recover potato lipids from potato juice by heat-coagulation (method 1) and by direct centrifugation of potato juice (method 2). The heat coagulation results in extensive protein loss in the juice, up to 95%, and prevents isolation of native potato proteins. Centrifugation removes less protein than heat coagulation, but is ineffective in removing turbidity. In fact, the control sample in example 1 corresponds to such a treatment. Both methods result in lipid levels of 22% or less. The lipid isolate is described as “lightly coloured”. Inadequate control of lipolysis and lipid peroxidation causes oxidative bleaching of the brightly coloured carotenoid antioxidants.

Edens, 1997, WO 97/42834 “Novel food composition”, describes isolation of native potato proteins by flocculation and subsequent ultrafiltration and diafiltration. Edens does not describe isolation of potato lipids without affecting the native proteins in the juice.

If the juice could be fully clarified and devoid of precursors that adhere and aggregate in time prior to protein isolation, equipment lifetime would increase, with all associated advantages such as in process efficiency and environmental burden. In addition, the insoluble material, though representing only a minor portion in the juice, may turn out a valuable material due to the high volumes with which starch juices are usually processed. Thus, it is an object of the invention to provide a method which allows for the aggregation of the different insoluble materials and precursors thereof into a single material that can be effectively separated from root or tuber juice, while leaving intact the soluble native protein and while providing a fully clarified potato juice. A good measure of protein nativity is a high solubility.

### FIGURES

FIG. 1A: Influence of charge density on turbidity.

FIG. 1B: Influence of viscosity on turbidity

FIG. 1C: Contour plots showing the “sweet spot” of specific viscosity and charge density for polyacrylamides in the flocculation of potato juice in terms of final turbidity.

FIG. 2: Contour plots showing the “sweet spot” of specific viscosity and charge density for polyacrylamides in the flocculation of potato juice in terms of floc size.

FIG. 3: Increase in phosphate in potato juice over time. Over the course of two hours, the phosphate level rises from 12 mM to 20 mM.

FIG. 4: Carrageenan-flocculation of diluted potato juice at different potassium levels. The turbidity is expressed as the turbidity in an undiluted juice to aid comparison with other figures and tables.

FIG. 5: Settling of flocs over time with different weighting agents.

### DETAILED DESCRIPTION

The invention provides a method of clarifying root or tuber juice, comprising contacting a root or tuber juice with a coagulant and a flocculant to form a floc material, wherein

a) the coagulant comprises a cationic coagulant and the flocculant comprises an anionic polyacrylamide with a specific viscosity of 4-6 mPa·s and a charge density between 45 and 75%; or

b) the coagulant comprises a polymeric silicate of formula SiO₃²⁻ and the flocculant comprises a cationic polyacrylamide with a specific viscosity of 3-5 mPa·s and a charge density of at most 30%; or

c) the coagulant comprises a cationic coagulant and the flocculant comprises carrageenan;

and wherein the floc material is subsequently isolated from the juice to obtain a clarified root or tuber juice and a floc material.

Roots and tubers are defined as plants yielding starchy roots, tubers, rhizomes, corms and stems. They are used mainly for human food (as such or in processed form), for animal feed and for manufacturing starch, alcohol and fermented beverages including beer.

Roots and tubers include the species of potato (Solanum tuberosum or Irish potato, a seasonal crop grown in temperate zones all over the world); sweet potato (Ipomoea batatas, a seasonal crop grown in tropical and subtropical regions, used mainly for human food); cassava (including Manihot esculenta, syn. M. utilissima, also called manioc, mandioca or yuca, and also including M. palmata, syn. M. dulcis, also called yuca dulce, which are semi-permanent crops grown in tropical and subtropical regions); yam (Dioscorea spp), widely grown throughout the tropics as a starchy staple foodstuff); yautia (a group including several plants grown mainly in the Caribbean, some with edible tubers and others with edible stems, including Xanthosoma spp., also called malanga, new cocoyam, ocumo, and also including tannia (X. sagittifolium)); taro (Colocasia esculenta, a group of aroids cultivated for their edible starchy corms or underground stems, grown throughout the tropics for food, also called dasheen, eddoe, taro or old cocoyam); arracacha (Arracacoa xanthorrhiza); arrowroot (Maranta arundinacea); chufa (Cyperus esculentus); sago palm (Metroxylon spp.); oca and ullucu (Oxalis tuberosa and Ullucus tuberosus); yam bean and jicama (Pachyrxhizus erosus and P. angulatus); mashua (Tropaeolum tuberosum); Jerusalem artichoke (topinambur, Helianthus tuberosus). Preferably, the root or tuber is a potato, sweet potato, cassava or yam, and more preferably the root or tuber is a potato (Solanum tuberosum).

Root or tuber juice, in the present context, in an aqueous liquid derived from roots and/or tubers by for instance pressing, grinding and filtering, pulsed electric field treatment, as the runoff from water jets for the production of processed potato products like chips and fries or by other means known in the art. Settling insoluble solids are essentially absent in a juice, but a juice as obtained usually comprises insoluble particles, which do not or barely settle by gravity, and which are responsible for the aqueous liquid's turbidity. These insoluble particles include among others lipids, insoluble proteins, salts, cell wall debris and components such as pectins, celluloses, and hemicelluloses, and aggregates thereof.

A juice in the present context may be used as obtained, or it may optionally be diluted or concentrated prior to the present method. Also, other pretreatments which leave the juice's molecular components more or less intact (i.e. retaining natural functionality) are contemplated for use with the present invention. An example of a pretreatment which may be suitable is adjustment of the pH of the juice. The pH may be adjusted by any means known in the art; pH adjustment can suitably be achieved by addition of for instance strong acids such as HCl, H₂SO₄, H₃PO₄, by addition of weak acids such as acetic acid, citric acid, formic acid, lactic acid, gluconic acid, propionic acid, malic acid, succinic acid and tartaric acid, by addition of strong bases such as NaOH, KOH, or by addition of weak bases such as ammonia, soda, potash or a suitable conjugated base of the acids above.

Another example of a pretreatment which may be suitable is modification of the conductivity through the addition of salts or the removal thereof via such methods as diafiltration or capacitive deionization. Another suitable pre-treatment can be microfiltration of the juice prior to the present method.

Preferably, juice of roots and tubers to be clarified with the present method is juice used in starch manufacture, because such juices are readily available on a large scale.

Clarification of root or tuber juice in the context of the present method means that for instance insoluble molecules, particles and/or aggregates, and precursors that can form aggregates in time, are removed from the juice, to result in a clear solution, which stays clear. Collectively, the insoluble molecules, particles, aggregates, and/or precursors which are responsible for the juice's turbidity, are called insoluble particles. Insoluble particles in the present context generally have a negative charge, or a negative zeta potential.

Whether an insoluble particle has a negative charge can be determined by measuring the electrophoretic mobility in an applied electric field via laser Doppler anemometry, microelectrophoresis or electrophoretic light scattering.

Whether an insoluble particle has a negative zeta potential can be calculated from electrophoretic mobility measurements as is known in the art.

Whether a juice is clear, in the present context, is decided by determining the optical density at 620 nm (OD620). The optical density (also called absorbance) is determined against a standard of deionized water and is preferably less than 0.8 for a clarified juice, more preferably less than 0.6, even more preferably less than 0.5, even more preferably less than 0.4 and optimally less than 0.3. Clarification should also result in flocs with a proper density to allow separation of the flocs from the juice, and clarification should result in little protein loss, such as less than 10%, preferably less than 5%, more preferably less than 2%.

An advantage of a clarified juice, in the context of the present invention, is that the coagulation and flocculation does not influence the native state of dissolved protein in the root or tuber juice, preferably potato juice. Thus, clarification allows for the insoluble particles to be removed, prior to isolation of native protein. Addition of a clarification step as presently described increases the efficiency of processes for isolation of native protein, with advantages in equipment lifetime, process economy, and reduction of waste.

Clarification of the root or tuber juice is achieved by contacting the solution with a coagulant and a flocculant. This results in clarification of the potato juice with a protein loss of less than 10%, preferably less than 5%, more preferably less than 2%.

In the context of the present invention, coagulation is the process of decreasing or neutralizing the negative charge or negative zeta potential of insoluble particles by interaction with the coagulant, so that the insoluble particles display an initial aggregation, thereby forming microflocs. This process is reversible, so that microflocs exist in a dynamic equilibrium with the surrounding juice, which limits their size depending on the conditions. Microflocs have a very loose consistency, which is such that they cannot themselves be isolated from the solution.

Flocculation, in the present context, is the process of bringing together microflocs under the influence of a flocculant to form large agglomerates. Thus, the flocculant adsorbs microflocs. The agglomerate of microflocs absorbed to a flocculant is called a floc in the present context. Although flocs might break, the formation of flocs is in principle not reversible. In contrast to microflocs, flocs can be isolated from the solution by means disclosed elsewhere in the application. Multiple isolated flocs can be called floc material, but the term floc material may also refer to a multitude of flocs which are present in a liquid, such as potato juice.

Three different methods a, b and c for the coagulation and flocculation of potato juice can be distinguished.

Method A

The coagulant comprises a cationic coagulant and the flocculant comprises an anionic polyacrylamide with a specific viscosity of 4-6 mPa·s and a charge density between 45 and 75%

In method a), the coagulant is a cationic coagulant. A cationic coagulant is a positively charged molecular species, which is suitable for aggregating insoluble particles present in root or tuber juice. Suitable cationic coagulants include quaternary ammonium species, including protonated tertiary, secondary or primary ammonium species. In case protonated tertiary, secondary or primary ammonium species are used as cationic coagulant, it is preferred if the pH of the juice is adjusted to a pH of 5.4 or lower (which results in approximately 90% protonation, or more).

Examples of suitable cationic coagulants are epiamines, polytannines, polyethylene imines, polylysines and cationic polyacrylamides.

Epiamines are polyether amines, preferably of MW 400,000 Da through 600,000 Da.

Polytannines are polymers of tannic acid, optionally treated with metal ions.

Polyethylene imines are polymers of iminoethylene, both branched and linear.

Polylysines are polymers of lysine, linked via the epsilon amino group rather than via the alpha group.

Cationic polyacrylamides are polymers of acrylamide, substituted with quarternary amines such as trialkyl amino methacrylates, preferably dimethylaminoethyl methacrylate methyl chloride. These polymers preferably have MW's of 1 MDa through 10 MDa.

Preferably, the cationic coagulant comprises an epiamine, a polytannine, a polylysine or a polyethylene imine, more preferably a epiamine, a polytannine or a polyethylene imine.

The flocculant comprises an anionic polyacrylamide with a specific viscosity of 4-6 mPa·s and a charge density between 45 and 75%. An anionic polyacrylamide is a polymer or copolymer of acrylamide, substituted with anionic groups such as sulphonic or carboxylic acid groups, preferably carboxylic acid groups. The anionic polyacrylamide can be a copolymer comprising at least an anionic unit and at least an acrylamide unit, wherein the monomers can be selected from acrylamide, methacrylamide, acrylic acid and methacrylic acid.

Preferably, the anionic polyacrylamide comprises units substituted with carboxylic acid such as acrylate.

The specific viscosity the anionic polyacrylamide is 4-6 mPa·s, preferably 4.7-5.6 mPa·s, more preferably between 5 and 5.4 mPa·s. The specific viscosity can be determined by recording the time required for a dilute solution, typically 0.5% w:v of the polyacrylamide to flow through a viscometer, yielding the viscosity. The specific viscosity is calculated from this value by subtracting the solvents viscosity and dividing by the solvents viscosity. The resulting value, the specific viscosity, expresses the relative increase in viscosity due to the presence of the polyacrylamide.

The charge density of an anionic acrylamide is between 45 and 75%, preferably between 50 and 70%, more preferably between 50 and 60%. The charge density is a measure for the relative amount of charged units relative to all units incorporated in the anionic polyacrylamide, and can be determined by conductometric or potentiometric titration, infrared spectroscopy, NMR spectroscopy or differential scanning calorimetry.

The molecular weight of the anionic acrylamide can be between 1 and 20·10⁶ Da, preferably between 5 and 15·10⁶ Da.

The weight ratio between flocculant and coagulant may be between 1:3 and 1:50, preferably between 1:5 and 1:20, more preferably 1:10.

Preferably, contacting the root or tuber juice with a cationic coagulant and an anionic flocculant comprises addition of the cationic coagulant to the juice prior to the addition of the anionic flocculant.

Method B

The coagulant comprises a polymeric silicate of formula SiO₃²⁻ and the flocculant comprises a cationic polyacrylamide with a specific viscosity of 3-5 mPa·s and a charge density of at most 30%.

In method b), the coagulant comprises a polymeric silicate of general formula SiO₃²⁻, i.e. the polymeric silicate is a linear or cyclic silicate. Preferably, the polymeric silicate is a prepolymerized linear or cyclic silicate, which is prepolymerized by exposing it to a polymeric cationic material such as cationic starch, cationic polyacrylamide or a polymeric salt such as polymeric aluminum salt or a combination of such materials, allowing the components to form an electrostatic complex. Further preferably, the polymeric silicate is a polyelectrolyte, preferably an anionic polyelectrolyte, which may comprise multiple metallic ions, such as a polymerized silicate comprising a basic aluminum salt.

Preferably, the coagulant comprises a silicate that is modified with a cationic polymer.

The flocculant comprises a cationic polyacrylamide with a specific viscosity of 3-5 mPa·s and a charge density of at most 30%.

A cationic polyacrylamide in this context is a polymer or copolymer of an acrylamide and optionally other monomers, which contains cationic groups. Suitable cationic groups include quaternary ammonium groups, and suitable monomers include trialkyl amino methacrylates, preferably dimethylaminoethyl methacrylate methyl chloride.

The specific viscosity of a cationic polyacrylamide is 3-5 mPa·s, preferably 3-4 mPa·s, more preferably 3.2-3.6 mPa·s. The specific viscosity can be determined as described above.

The charge density is a measure for the relative amount of charged units relative to all units incorporated in the anionic polyacrylamide, and can be determined as described above. The charge density of a cationic polyacrylamide is at most 30%, preferably at most 25%, more preferably at most 20%, even more preferably at most 15%, even more preferably at most 10%.

The molecular weight of the cationic acrylamide can be between 1 and 20·10⁶ Da, preferably between 5 and 15·10⁶ Da.

The ratio between flocculant and coagulant may be between 1:10 and 1:10.000, preferably between 1:25 and 1:2.500, more preferably between 1:200 and 1:300.

Preferably, contacting the root or tuber juice with a polymeric silicate coagulant and a cationic flocculant comprises addition of the polymeric silicate coagulant to the juice prior to the addition of the cationic flocculant.

Method C

The flocculant is a helix-forming polysaccharide. Without wishing to be bound by this theory, we believe that such flocculants work by interacting with insoluble particles in the juice while the flocculant is in the unfolded state. Upon undergoing a transition to a helical state, the volume occupied the flocculant shrinks drastically, thereby pulling together many particles in a single floc. Such helix-forming polymers are characterised by their chemical nature and belong to the class of polysaccharides with α1-3 and α1-4 glycosidic bonds. Ideally, the flocculant undergoes its transition to the helical state by binding cations that are endogenously present in the juice, such as alginates which use calcium and κ-carrageenans which use potassium. The use of alginates however suffers from the disadvantage that the level of free calcium in biological juice varies strongly over time because it precipitates with phosphates and free fatty acids. When the level of available calcium falls to low, alginate ceases to function as a flocculant. Ideally then, carrageenan, in particular κ-carrageenan, is used as a flocculant. However, care should be taken in introducing this compound into the juice. At endogenous levels, the potassium in the juice will induce helix formation at a rate that is too rapid to properly allow the flocculant to interact with insoluble particles, resulting in incomplete inclusion of these materials in the flow. This is avoided by introducing a synergistic polymer.

A synergistic polymer is capable of binding both to insoluble particles, acting essentially as a coagulant, and binding to the flocculant, thereby retarding the helix formation which allows higher levels of inclusion in the floc. Ideally therefore in method c), the coagulant comprises a cationic or neutral coagulant and the flocculant comprises carrageenan. In method c), any cationic coagulant can be used, but preferably, the cationic coagulant is the same cationic coagulant as described for method a). Alternatively or additionally, a neutral coagulant can be used, which may be selected from for instance the group of starch, amylopectin and/or κ-, ι- and/or λ-carrageenan.

The flocculant in method c) comprises carrageenan, a natural family of linear sulphated polysaccharides that are extracted from red edible seaweeds. Several types of carrageenan exist: κ-carrageenan has one 1 sulphate per disaccharide, ι-carrageenan has 2 sulphates per disaccharide, and λ-carrageenan has 3 sulphates per disaccharide. Preferably, the flocculant comprises κ-carrageenan, and more preferably the flocculant is a κ-carrageenan.

Method c) also allows for the option of using a single carrageenan as both coagulant and flocculant, such as i-carrageenan. A preferred option for method c) is to use a mixture of κ- and ι-carrageenan, as the flocculant and the coagulant. Alternatively, the carrageenan flocculant is combined with a neutral or cationic coagulant which is not carrageenan.

The molecular weight of the carrageenan can be between 50,000 Da and 20·10⁶ Da, preferably between 1·10⁵ and 5·10⁶ Da.

The ratio between flocculant and coagulant may be between 9:1 and 1:9, preferably between 7:3 and 3:7, more preferably between 6:4 and 4:6.

Preferably, the coagulant is added and mixed through the solution prior to the addition of the flocculant.

Between methods a, b and c for clarifying a root or tuber juice, methods a and c are preferred, and most preferred is method c. An alternative most preferred method is method a).

Optionally, a surfactant is present during the formation of the floc material by any of the above methods a-c. Addition of a surfactant increases clarity of the potato juice even further, potentially by the surface-tension lowering effect of the amphiphilic molecules. Preferably, the surfactant is added at a concentration below the critical micelle concentration (CMC). The CMC is highly surfactant-dependent, but the CMC of commercial surfactants can easily be retrieved from well-known handbooks and product sheets.

Surfactants in the present context are generally cationic surfactants. In general, any cationic surfactant can be used. Preferred surfactants in the context of the present method are quaternary ammonium-based surfactants, preferably cetylpyridinium and cetyltrimethylammonium surfactants, such as chlorides, bromides and iodides, more preferably cetylpyridinium or cetyltrimethylammonium chloride. Other preferred surfactants are lauric alginate, cocamidopropylbetaine, lauramidopropyl dimethylamine, lauryl betaine, benzalkonium chloride, and chlorhexidin.

Generally, the invention pertains to clarifying root- or tuber juice by contacting the juice with a coagulant and a flocculant to form a floc material, which is subsequently isolated. The floc material generally comprises at least part of the insoluble particles that were present in the root- or tuber juice as turbidity. The floc material is visible by eye after formation, and can be isolated to obtain an isolated floc material.

Contacting in the present context means that the juice, the coagulant and the flocculant are combined and mixed to such an extent that floc material forms. Contacting may occur in any order; a premix of coagulant and flocculant may be formed and added to the juice, but also the flocculant may be added to the juice, followed by the coagulant. Juice may be added to a mixture, such as a solution or dispersion, of coagulant, flocculant or both, and any other way of contacting the juice, coagulant and flocculant to obtain floc material. Preferably, the juice is combined first with the coagulant, and subsequently, the flocculant is added. The interval between combining juice with coagulant and combining said mixture with flocculant is preferably within a few hours, such as less than 2 hours, preferably less than 1 hour, more preferably less than half an hour, even more preferably less than 15 minutes, such as preferably less than 5 minutes, or more preferably between a half and one-and-a-half minutes.

The combined juice, coagulant and flocculant is subsequently allowed to form floc material. Formation of floc material generally takes less than 2 hours, preferably less than 1 hour, more preferably less than half an hour, even more preferably less than 15 minutes, such as preferably less than 10 minutes, preferably between 1 and 5 minutes.

Preferably, flocs formed in potato juice have a single density which is higher than the density of the juice to allow isolation of the flocs. A suitable floc density is at least at least 1.23 g/cm³, preferably at least 1.29, more preferably at least 1.35.

Isolation of the floc material may be achieved by any means known in the art, such as by filtration, sedimentation, centrifugation, cycloning, heat fractionation and/or absorption. Isolation results in a clarified juice as described above, and in an isolated floc material.

Filtration is a technique wherein the floc material is isolated on a filter which allows passing of the aqueous juice, but holds the floc material. For filtration, the particles should have a size of at least 30 μm², preferably over 50 μm² more preferably over 80 μm². The particle size of flocs can be determined by optical back reflection measurements of laser light by a PAT sensor system (Sequip) and is expressed here as the surface area of the median of the particle population in square micrometers. Suitable filter sizes for filtration are 18-250 μm, preferably 50-200 μm, more preferably 80-180 μm.

Sedimentation is a technique which makes use of the different densities of the floc material. Higher density materials sink in materials of lower density by gravitational forces, so that if the density of the floc material is higher than the density of the clarified juice, the floc material sinks and collects on the bottom, from which it can be isolated by various means known in the art. Sedimentation can usually be achieved within 2 hours, preferably within one hour, more preferably within 30 minutes, even more preferably in 10 minutes.

Centrifugation also makes use of the difference in density between the clarified juice and the floc material, but centrifugation is usually used in cases where the difference in density between floc material and clarified juice is relatively small. In such cases, centrifugation provides an extra mechanical centrifugal force, which aids in collecting the floc material at the bottom of the juice container. Centrifugation can conveniently be done at 500-5000 g, preferably 800-2900 g.

Cycloning, such as axial hydrocycloning, also makes use of density differences between the clarified juice and the floc material. Cycloning can be used to isolate the floc material from the clarified juice by using concurrent axial hydrocyclones under conditions that result in g-forces in excess of 4000 g.

Floc material may also be isolated by absorption on a hydrophobic adsorbent followed by elution induced via pH shift or salt gradient, and subsequent evaporation of the elution solvent.

Preferably, the floc material is isolated from the clarified juice by filtration, sedimentation and/or centrifugation. More preferably, a combination of sedimentation and filtration is used.

Optionally, isolation may be aided by the addition of weighting agents. Weighting agents in the present context are solids with a density of 1.5 to 8 g/cm³, preferably 2.0-3.0 g/cm³, which have affinity for the floc material during or after formation. As such, the weighting agents at least partially become included in the floc material, thereby increasing their density. This facilitates removal of the floc material by for instance sedimentation or centrifugation.

Suitable weighting agents are for instance metals, clays and inorganic salts. Suitable metals include iron and aluminum, preferably iron. Suitable clays include kaolin, talcum, bentonite, preferably kaolin. Suitable inorganic salts include phosphates, carbonates and oxides, such as phosphates, carbonates and oxides of iron, calcium, magnesium. Preferred inorganic salts are calcium carbonate and calcium hydrogen phosphate.

While one might a priori assume that higher densities are preferable, in practice high density particles display a tendency to “fall through” a floc, thereby disrupting the floc structure and hampering flocculation. Thus, it is preferred that weighting agents have a density of 1.5 to 8 g/cm³, preferably 1.5 to 5 g/cm³, more preferably 2.0 to 3.0 g/cm³.

Moreover, the presence of d-block metals, either pure or as salts, tends to catalyze the oxidation of phenolic compounds in potato juice resulting in an unattractive dark color in the final protein product. Thus, it is preferred if weighting agents do not comprise d-block metals.

Finally, materials that are high on the Mohs Hardness scale can wear down factory equipment over time. Hence, materials that combine the properties of a density higher, but not too much higher than the density of the floc material are preferred weighting agents. In addition, a low Mohs hardness and a relatively inert chemical nature are vastly preferred.

Mohs hardness is determined by ability of different materials to scratch and to be scratched by each other and ordering these materials on a scale ranging from softest (e.g. talcum at a value of 1) to hardest (e.g. diamond at a value of 10). Each material can scratch others that are lower on the scale, and is scratched in turn by materials higher on the scale. Scratching, in the present context, means to leave a permanent dislocation that is visible to the naked eye. The Mohs hardness can be determined by scratching a given material using a Mohs hardness kit or with hardness picks that are tipped with selected materials.

Since steel that is used in factory equipment has a Mohs hardness between 4 and 4.5 it is preferred that weighting agents for the present invention are softer than this. Thus, weighting agents preferably have a Mohs hardness of less than 4.5, more preferably less than 4, even more preferably less than 3.5. The Moh hardness should be at minimum 1.

Thus, the invention further pertains to a method wherein the density of the floc material is increased by inclusion of weighting agents in the floc material.

It is an advantage of the method of the invention that clarified potato juice can be separated from the floc material with high efficiency. In processing root- and tuber juices, liquid recovery is an important aspect, because the clarified juice is subsequently used to isolate native protein. Isolation of native protein requires equipment for removal of floc material that does not denature the protein, but still allows sufficient passage of juices. Flocculation according to the present method generally results in flocs that are easily removed with a density of at least 1.23 g/cm³, preferably at least 1.29 g/cm³, more preferably at least 1.35 g/cm³, while resulting in a clear juice with OD620 of less than 0.8, preferably less than 0.6, more preferably less than 0.5 and most preferably less than 0.3, with a loss of soluble protein of less than 10% of the total soluble protein, preferably less than 5% of total soluble protein, more preferably less than 2%. The amount of soluble protein in turbid and clear solutions can be determined by determining the total quantity of protein using the SPRINT rapid protein analyser (CEM) before and after a mild centrifugation step (800 g, 1 minute).

Among others filtration, sedimentation and/or centrifugation allow for juice recovery of at least 88%, preferably at least 90%, and more preferably at least 93%, optimally at least 95%.

The recovered juice has an OD620 of less than 0.8, preferably less than 0.6, more preferably less than 0.5, even more preferably less than 0.4 and even more preferably less than 0.3, and is highly suitable for protein isolation. Alternatively, the juice can be used for the recovery of phenolic dyes, free amino acids and organic acids.

In addition, the juice generally comprises at least 0.5 wt. %, preferably at least 0.75 wt. %, more preferably at least 0.9 wt. %, such as at least 0.94 wt. % of dissolved native protein, even more preferably at least 1 wt. %, or even at least 1.1 wt. %. The solubility of the protein after isolation from the juice is preferably at least 80%, more preferably at least 85%, even more preferably at least 95%, such as at least 95% or even at least 98%. The protein solubility can be determined by dispersing the protein in water, dividing the resulting liquid into two fractions and exposing one fraction to centrifugation at 800 g for 5 minutes to create a pellet of non-dissolved material and recovering the supernatant. By measuring the protein content in the supernatant and in the untreated solution, and expressing the protein content of the supernatant as a percentage of that in the untreated solution, the solubility is determined. Convenient methods to determine the protein content are via the Sprint Rapid Protein Analyser (CEM), by measuring the absorbance at 280 nm or by recording the Brix value but any method that is known in the art can be used.

In addition, the clarified juice contains less than 50 mM calcium, preferably less than 20 mM and more preferably less than 12.5 mM. Optimally, the clarified juice contains no added calcium. The calcium content can be determined by atomic absorption spectrometry, flame emission spectrometry, x-ray fluorescence, permanganate titration or gravimetric titration using oxalic acid; the amount of added calcium can be determined by calculation from the amount of any calcium added, or by calculating the increase in the amount of calcium after adding calcium to the juice, relative to the natural juice prior to addition of calcium.

As such, the invention also pertains to a clarified root or tuber juice, obtainable by the present method, comprising at least 0.1 wt. % of dissolved protein, wherein the protein is native and wherein the clarity, expressed as OD620, is less than 1.

For the above reasons, the present method of flocculation increases the efficiency of the protein recovery by removal of insoluble particles that otherwise would clog membranes and foul equipment. Chromatography columns would display increased operating pressures leading to more frequent cleaning cycles. In addition, particulate matter tends to adhere to sensors leading to a loss of process control.

Proper flocculation results in longer operating times of equipment, less downtime for cleaning and reduced usage of cleaning chemicals, as well as a lower environmental burden.

In addition, the isolated floc material has favorable properties, such as a favorable fatty acid profile, a favorable content of free amino acids, and a high content of carotenoids, which allows separate isolation of new and valuable potato materials. Therefore, the invention similarly pertains to the isolated floc material.

The floc material is a material comprising insoluble particles such as water-insoluble lipids and water-insoluble proteins from root- or tuber juice, as well as charged species such as salts and free amino acids, and further comprising a coagulant and a flocculant as described above. Optionally, one or more weighting agents and/or one or more surfactants may also be present.

The floc material comprises flocs with a particle size, expressed as surface area of the median of the particle population, of at least 50 μm², preferably at least 60 μm², more preferably at least 80 μm². The surface area of the median of the particle population can be determined by optical back reflection measurements of laser light by a PAT sensor system (Sequip).

The floc material preferably has a density of at least 1.23 g/cm³, preferably at least 1.29 g/cm³, more preferably at least 1.35 g/cm³. The floc material is characterized in that it has a single, uniform density; in a sucrose gradient system, the material shows as a single band. This shows that the floc material is a homogenous material. Also, the floc material has a particle size distribution which allows for fast sedimentation. The density of floc material is determined by sucrose density centrifugation.

The floc material after isolation from the clarified juice generally has a dry matter content of 1-10%, preferably 3-6%. Optionally, the dry-matter content can be increased by concentration. Suitable means of concentration include freeze crystallization, extensive dewatering by a belt filter or by removing water using evaporators, spraydrying, agitated thin film driers or liquid CO₂ extraction, which may result in an increase in dry matter content to above 50%. Also, instead of or after concentration, the floc material can be dried. Drying can be done by any means known in the art, such as by drying at increased temperature, drying in vacuo, or freeze-drying. Drying decreases the water content of the flocs, such as to a water content of 12-8 wt. %, preferably 8-4 wt. %.

Generally, the floc material comprises among others potato lipids. Potato lipids include phospholipids, such as phosphatidylcholine and ethanolamine, and further include glycolipids and neutral lipids, such as triglycerides and diglycerides. The floc material generally comprises 18-38 wt. % lipids, based on total dry matter, preferably 23-33 wt. % lipids, and more preferably 25-30 wt. % lipids.

The floc material further comprises potato free fatty acids. Potato free fatty acids are saturated and unsaturated fatty acids, in particular linoleic acid and linolenic acid. Potato polar lipids are sensitive to hydrolysis upon destruction of the tuber in a pH dependent manner. Hence, the quantity of intact lipids and free fatty acids varies depending on the conditions of isolation. This explains the large variance of lipid compositions that has been reported in the scientific literature. The floc material in the present invention comprises between 5-60 wt. % free fatty acids based on total dry matter, preferably between 10-40 wt. % of free fatty acids.

Generally, the fatty acid profile of potato lipids is very favorable, with a relatively high degree of unsaturation. Unsaturated fatty acids are highly preferred fatty acids in lipid materials for human and animal food purposes. The floc material further comprises a high level of carotenoids, such as lutein and astaxanthin. Carotenoids, also, are considered favorable for human and animal food purposes because they have beneficial health effects, in particular the avoidance of blindness. The level of carotenoids in the floc material is generally between 15-150 mg/kg, preferably between 30-75 mg/kg based on total dry matter.

The floc material further comprises protein, in particular insoluble protein. Protein typically comprised in the floc material includes patatin and protease inhibitors as well as many membrane proteins and insoluble structural proteins. Generally, the floc material comprises between 55-80 wt. % protein, based on total dry matter, preferably between 60 and 70 wt. %.

The floc material further comprises free amino acids. Free amino acids constitute between 1.3 wt. % and 5 wt. % of dry matter in the floc. In the following, the terms free amino acid and amino acid are used interchangeably; amino acids occurring in peptides or proteins are not considered part of the (free) amino acids in the present context. Amino acids, in the present context, are L-α-amino acids.

The floc material further comprises a coagulant and a flocculant as described above. Generally, the coagulant is not present at a mass ratio, based on total dry-matter, of more than 15%, preferably no more than 10%, more preferably no more than 5%. Similarly, the flocculant is not present at a mass ratio, based on total dry-matter, of more than 5%, preferably no more than 1%, more preferably no more than 0.1%.

A floc material of the invention has the advantage that it is non-allergenic, and generally is not derived from animals or from genetically modified organisms (GMO). Furthermore, the floc material of the invention contains nutritious essential lipids, free fatty acids, proteins, free amino acids and caretenoids, similar to nutritious vegetables. The floc material is available at large scale and suitable for food applications and/or nutritional supplements.

The floc material may be used as such or further processed. An example of use of a floc material that is obtained with food grade flocculants is for instance as a feed material or food ingredient. Preferably, floc material used for food grade applications contain no weighting agent. Alternatively, floc material may find use as a source of specialized root or tuber enzymes, such as polysaccharide-modifying enzymes and/or oxido-reductases; these enzymes fractionate with the lipid material, and not with the juice.

The isolated floc material can be further processed, such as by extraction, to isolate various classes of valuable compounds. Preferably, the isolated floc material is subjected to concentration and/or drying prior to further processing.

Lipid extraction can be achieved through any means known in the art such as pressing or melting followed by phase separation, freeze-crystallization of lipids, microwave hydrodiffusion, washing away the non-lipid components or extraction with an organic solvent or a supercritical gas. Preferably, lipid extraction results in isolation of a lipid fraction from at least the coagulant and/or the flocculant, and from the weighting agents, if used.

Preferably, lipid extraction is achieved through organic solvent extraction, such as with one or a mixture of the organic solvents methanol, ethanol, propanol, isopropanol, acetone, ethyl acetate, diethyl ether, t-butyl-methyl ether, pentane, hexane, heptane, benzene, toluene, tetrahydrofuran, chloroform, dichloromethane, carbon disulfide, ethyl lactate, methylene chloride. Alternatively, liquid extraction is achieved through supercritical gas extraction, such as by extraction with supercritical carbon dioxide (CO₂). Lipid extraction results in extraction of at least part of the root or tuber lipids from the floc material, thereby resulting in a lipid isolate.

A lipid isolate according to the invention comprises 9-15% glycolipids, 25-40% phospholipids, with the bulk of the remainder made up out of free fatty acids and neutral lipids. The bulk of the fatty acids, both free and lipid-bound, is made up out of polyunsaturated fatty acids such as linoleic and linolenic acid the sum of which takes up 35-65 wt. %, relative to dry matter lipid isolate. In addition, oleic acid is present (2-10 wt. %), as well as palmitic acid (20-40 wt. %), stearic acid (6-10 wt. %) and arachidic acid (2-3 wt. %). The lipid isolate usually also contains essentially all carotenoids from the floc material, such as between 0.03 wt. % and 1.25 wt. %.

The lipid isolate has a favorable fatty acid profile with a high degree of unsaturation, and high quantities of carotenoids, plant sterols and acetylcholine. Glycoalkaloids are present at food-grade acceptable quantities, such as 1000 mg/kg, preferably below 312 mg/kg, even more preferably below 150 mg/kg. A further advantage of the potato lipid isolate is that it is allergen-free, and generally not derived from genetically modified organisms (GMO). Also, since it is not derived from animals it is substantially free of cholesterol.

A potato lipid isolate according to the invention may have various applications, such as
application in emulsifying liquids;
in medical use such as skin moisturizers and eye drops, as an acetylcholine source against symptoms of dementia, anxiety, treatment of gall stones, liver disease, treatment of blocked lactiferous ducts;
recovery of nutritional fatty acids and lipids;
recovery of plant sterols;
isolation of carotenoids, in particular lutein, for prevention of glaucoma;
isolation of bio-plastic building blocks, such as 9-oxo-nonanoic acid;
A lipid nutritional enhancer in food applications, such as in dough and in bread.

Optionally, the potato lipid isolate can be further fractionated into the constituent lipids, such as by selective solvent extraction using for example one or more from the organic solvents methanol, ethanol, propanol, isopropanol, acetone, ethyl acetate, diethyl ether, t-butyl-methyl ether, pentane, hexane, heptane, benzene, toluene, tetrahydrofuran, chloroform, dichloromethane, carbon disulfide, ethyl lactate and methylene chloride to separate the lipids into a polar and a neutral fraction. Alternatively, fractionation of the potato lipid isolate may be achieved by crystallization, chromatographic methods or absorption.

A lipid isolate according to the invention is different from a floc material in that the lipid isolate does not contain a coagulant or a flocculant, nor the bulk of the protein components of the floc, nor weighting agents.

Alternatively or additionally, free amino acids may be isolated from the floc material to obtain an amino acid material, by optionally disrupting the floc material, and subsequent extraction of amino acids.

Disrupting the floc material is optionally done prior to extraction of amino acids from the floc material, and may be done by addition of a solution comprising charged species, such as salts, acids or bases. The charged species should be present in an amount of 1M, preferably 0.1 M. Conveniently, the solution has a pH of below 3 to optimize the amino acid composition. Alternatively, the floc material may be disrupted by mechanical force such as shaking, grinding, grating or shearing.

Amino acids included in the (optionally disrupted) floc material can be isolated by extraction with an aqueous solution, which is optionally buffered, resulting in a water extract comprising an amino acid material. Optionally, the water extract is subsequently dried to obtain the amino acid material in a dry powder form. Amino acids, in the present context, are L-α-amino acids.

Extraction of the amino acid material can be done by subjecting the (optionally disrupted) floc material to an aqueous solution. Optionally, the aqueous solution comprises less than 50 vol % of a water-miscible organic solvent, such as methanol, ethanol or acetone. Further optionally, the aqueous solution is buffered, preferably using physiologically acceptable salts. The pH of the aqueous solution can be between 2 and 8, preferable between 3 and 7, and the temperature can be between 20 and 80° C., preferably between 20 and 30° C. In a preferred embodiment, extraction is performed with water.

Suitable buffers to achieve the desired pH are known in the art, and include for example phosphates, citrates, malates, propionates, acetates, formiates, lactates, gluconates, carbonates and/or sulphonates.

The water extract preferably comprises at least 0.5 wt. %, more preferably 1.4 wt. % of amino acid material.

The water extract may be optionally concentrated and/or dried to result in an amino acid material in a dry powder form. Suitable techniques include ultrafiltration, reversed osmosis and spraydrying. After drying the amino acid material is a dry powder with a dark yellow to brown color.

The amino acid material comprises amino acids, and may additionally comprise other potato-derived components. The amino acid material comprises, as a % dry weight,
free amino acids: 10-50%, preferably 13-30%
salts 9-12%
free sugars 9-12%
Organic acids 9-12%
Protein 0-41%, preferably 10-28%
Optionally other potato-derived components

The amino acids extracted from the floc material have a favorable amino acid profile. The amino acid material is enriched in among others the amino acids alanine, glutamic acid, glycine and valine, relative to potato juice before flocculation. Thus, extraction of the amino acid material from the floc material results in a relative increase in the amino acids alanine, glutamic acid, glycine and valine, relative to potato juice before flocculation.

Also, the amino acid material comprises a considerable proportion of glutamine and asparagine.

The amino acid material comprises, as a wt. % of free amino acids:
10-25% alanine, preferably 15-21%
15-35% asparagine, preferably 20-30%
5-16% glutamine, preferably 8-13%
5-9% valine, preferably 5.5-7%
0.1-3.5% glutamic acid, preferably 0.2-3%
0.5-10% glycine, preferably 1-8%

Preferably, the total amount of the amino acids alanine, glutamic acid, glycine, asparagine, and glutamine is 50-75 wt. % of all free amino acids, preferably 55-65 wt. %.

Preferably, the total amount of the amino acids alanine, glutamic acid, glycine, asparagine, glutamine and valine is 55-80 wt. % of all free amino acids, preferably 60-70 wt. %.

In addition, the amino acid material comprises minor amounts of glycoalkaloids, such as preferably below 312 mg/kg, more preferably 1-200 mg/kg, even more preferably 1-150 mg/kg.

The favorable amino acid profile of the amino acid material makes it highly suitable for application in food, or as a food supplement. Alanine, valine and glycine are well-known for their positive effect on muscle growth, and glutamic acid, asparagine and glycine can suitably be used as a taste enhancer. This particular composition in amino acids and other materials is different from the natural composition of potato juice, and therefore the direct result of the flocculation process.

The enrichment in the amino acids alanine, glutamic acid, glycine and valine due to flocculation is an unexpected advantage of the flocculation of potato juice, resulting in a potentially valuable potato-derived amino acid material.

A further advantage of the amino acid material is that it is allergen-free, and generally not derived from genetically modified organisms (GMO).

It has been found that the favorable amino acid composition of the amino acid material allows to be used as a taste enhancer, for example in the form of an additive. The composition provides a strong umami (savoury) taste, and is therefore highly suitable to apply in savoury applications, such as broths, bouillons, noodles, dressings, seasonings, sauces, ready-made meals or meal kits, or parts thereof, fonds, sauces, condiments, spice or herb compositions or, marinades.

In addition, the amino acid isolate can be used as a food supplement.

Thus, the invention also provides a method to prepare an amino acid material for use in food applications or food supplements, comprising flocculation of potato juice as described above, and further comprising extraction of the obtained floc material with an aqueous solution to obtain the amino acid material as an aqueous extract, and optionally concentrating and/or drying the amino acid material to provide the amino acid material in a dry powder form.

Also, the invention pertains to an amino acid material, obtainable by said process, the composition of which is described above.

For obtaining floc material suitable to extract amino acid material, flocculation according to method a) is preferred, more preferably flocculation using polytannine as the coagulant, and an anionic acrylamide as the flocculant. Preferably, carrageenan is additionally added during flocculation.

Isolates according to the invention (i.e. the potato lipid isolate and the amino acid material) have the distinct advantage that they are non-allergenic, and are generally not derived from animals or from genetically modified organisms (GMO). This makes them suitable for modern food applications. The isolates are available at large scale and suitable for nutritional supplements or additives.

The invention will now be illustrated by the following, non-limiting examples.

### EXAMPLE 1

Background

Potato protein purification requires a substantially clear potato juice in order to prevent clogging of the equipment. Potato juice is naturally quite turbid, hence a clarification step is required. We have found that a highly convenient method is flocculation. A flocculation step should ideally be compatible with food production and avoid damaging or losing the valuable native components of the potato juice by for example heating or high shear forces. In addition, ideally it should produce a solution that is free from undesired particles, slimes or gums and the flocculated particles should be of sufficient size and strength to settle rapidly. These parameters can be quantified as follows:

Turbidity as measured by spectrometry at 620 nm should preferably be below 0.8, preferably below 0.5 and even more preferably below 0.3. Particle size expressed as surface area should be above 50 square micron, preferably above 60 and even more preferable above 80. Protein loss should not exceed 10% of the recoverable protein. Flocs should display good settling behavior as determined by visual inspection.

Study Setup

Potato juice was subjected to flocculation by polyacrylamides of varying lengths and charge densities. The resulting clarified juices were analysed for protein loss and final turbidity, while the flocs were analysed for particle size. A visual indication of floc behavior was also recorded.

Preparation of Flocculant Solutions

160 mg κ-carrageenan (FMC Biopolymer GP812, 20031021) and 240 mg Wisprofloc N (AVEBE, a neutral pregelatinised potato starch coagulant) were dissolved in 1 liter of demineralised water preheated to 60° C. and stirred until dissolved. The solution was then cooled to ambient temperature.

Superfloc polyacrylamides (Kemira) of the types A110 (40714B), A120 (40718C), A130 (44685C), A137 (44720B), A130HMW (40722), A150LMW (44713), A150 (44693A), A150HMW (44824A) and A185 (44973) were dissolved at 1 g/L concentrations in demineralised water that was preheated to 60° C. and cooled down to ambient temperature.

Flocculation of Potato Juice by Carrageenan

400 mL of freshly prepared potato juice from mature tubers (cv. Averna) were stirred at 200 rpm in a 1 liter beaker. 100 mL of the flocculant solution was added at a rate of 100 mL per minute by a peristaltic pump while stirring at 200 rpm. Stirring continued for 1 minute and the juice was allowed to settle for 10 minutes. The resulting solution was centrifuged for 1 minute at 2900 g to simulate the centrifugal conditions of an industrial separator.

Flocculation of Potato Juice by Acrylamide

400 mL of freshly prepared potato juice from mature tubers (cv. Averna) were stirred at 200 rpm in a 1 liter beaker. 2.6 mL of a 5% (w:v) cetyltrimethylammonium chloride (CTAC) solution were added, followed by 2 mL of a 1% Ecotan Bio-10, a cationic polytannine coagulant, Serveco) while stirring. This was allowed to stir for 1 minute, after which 2 mL of a 1 g/L acrylamide solution were added. The juice was allowed to settle for 1 minute, followed by a 1 minute centrifugation step at 2900 g.

Protein Measurement

Protein concentrations were determined using a GEM Sprint Rapid protein analyzer that was calibrated against Kjeldahl measurements. Sprint measures the loss of signal of a protein-binding dye. The higher the loss, the more protein is present. This system is calibrated using Kjeldahl measurements on extensively dialysed protein samples so that all nitrogen that is detected will originate from protein and not from free amino acids or peptides. The nitrogen-number is then converted into a protein content by multiplying with 6.25.

Turbidity Measurement

Turbidity was measured by recording the absorbance at 620 nm in a BioRad Smartspec Plus spectrophotometer against demineralized water.

Particle Size Measurement

Particle sizes expressed as surface areas in square microns of the median of the particle population were recorded on a Sequip particle analyser (Sequip GmbH) that was set to measure particle size distributions in the 0.1-350 μm range.

Visual Indication of Floc Behavior

Quality of flocs can be estimated rapidly be visual observation. Proper flocs tend to form clearly visible structures that settle rapidly. Fair flocs tend to settle more slowly. Poor flocs form small, brittle aggregates that settle exceedingly slowly.

Results and Discussion

It was found that the use of a polysaccharide that is capable of undergoing a transition to a helical state results in a clear potato juice. Polysaccharides that are capable of such a transition are those that are characterized by α-1,3 and/or α-1,4 glycosidic bonds. Carrageenan, which is sensitive to helix induction by potassium naturally present in potato juice, was found to satisfactorily clarify potato juice by inducing proper flocs. Among the carrageenans, κ-carrageenan and a mixture of κ-carrageenan and ι-carrageenan are preferred. In the table below, flocculation with GP812 κ-carrageenan is reported, in combination with a neutral pregelatinised potato starch coagulant.

As for the polyacrylamide flocculation, it was found that anionic polyacrylamides with a specific viscosity of 4-6 mPa·s and a charge density between 45 and 75% in combination with a cationic coagulant result in proper flocs and clarified potato juice. Several common alternatives to polyacrylamide have been tested as well, but none of these materials shows desirable floc behavior.

TABLE 1
Effect of polyacrylamide flocculants and several
alternative to polyacrylamide flocculants on potato juice.

| | | | | % | | Floc |
|---|---|---|---|---|---|---|
| | Charge | Specific | | protein | D50 | behav- |
| Flocculant | Density | Viscosity | OD620 | loss | (um²) | iour |
| none | | | 1.287 | 10.3 | 10.4 | poor |
| GP812/ | | | 0.275 | 9.9 | nq | fair |
| whispro | | | | | | |
| A110 | 15 | 4.8 | 1.225 | 1.4 | 13.3 | poor |
| A120 | 20 | 4.9 | 1.287 | 0.2 | 29.2 | poor |
| A130 | 30 | 4.9 | 0.825 | 5.3 | 43.2 | poor |
| A137 | 40 | 5.9 | 1.221 | 9.5 | 31.3 | fair |
| A130HMW | 30 | 5.2 | 0.955 | 7.0 | 34.7 | poor |
| A150LMW | 55 | 3.6 | 0.884 | 5.7 | 42.5 | poor |
| A150 | 55 | 5.2 | 0.454 | 7.7 | 81.9 | Good |
| A150HMW | 55 | 6.5 | 0.678 | 8.3 | 84.0 | Good |
| A185 | 95 | 4.8 | 1.224 | 6.7 | 67.3 | fair |
| Guar gum | | | 1.16 | | 23.8 | poor |
| KP400 | | | | | | |
| Guar Gum | | | 1.18 | | 25.8 | poor |
| GU23/2F | | | | | | |
| Chitosan | | | 0.51 | | 16.6 | poor |
| Heppix | | | | | | |
| 85/5000/A | | | | | | |
| Xanthan | | | 0.944 | 5 | | poor |
| gum | | | | | | |
| Pectin | | | 0.698 | 10.1 | | poor |

nq) Not quantifiable due to incompatibility between the floc type and particle analysis

TABLE 2

| | | Chemical nature | Particle size | Turbidity | |
|---|---|---|---|---|---|
| Flocculant^{a} | Coagulant | of coagulant | D50 | (OD620) | |
| A150 | Bio10 | Polytannine | 114.29 | 0.176 | |
| A150 | Zetag IP 2M | Polyethylenimine | 99.63 | 0.17 | |
| A150 | Superfloc C583 | polyamine | 88.03 | 0.268 | |
| A150 | GP812 | carrageenan | 148.42 | 0.16 | |
| A150 | NG 30 | Polytannine | 85.57 | 0.219 | |
| A150 | Organofloc 475 | cationic metal salt | 25.68 | 1.25 | Reject |
| A150 | Biofloc 500 | Chitosan | 45.51 | 0.461 | Reject |
| LT 30 | Bio10 | Polytannine | 86.72 | 0.416 | |
| LT 30 | Magnafloc LT 31 | Epiamine | 92.31 | 0.308 | |
| LT 30 | Magnafloc LT 32 | Epiamine | 90.21 | 0.322 | |
| LT 30 | Siveele Chitosan | Chitosan | 6.81 | 0.93 | Reject |
| LT 30 | Heppix Chitosan 90/10/A1 | Chitosan | 7.76 | 0.83 | Reject |
| LT 30 | Magnafloc LT 35 | Polydadmac | 25.52 | 1.64 | Reject |
| LT 30 | MagnaflocLT 37 | Poiydadmac | 41.07 | 1.31 | Reject |
| LT 30 | MagnaflocLT 38 | Polydadmac | 32.81 | 0.86 | Reject |

^{a}Both A150 and LT 30 are anionic polyacrylamides with a charge density of 55% and a specific viscosity of 5.2.

### EXAMPLE 2

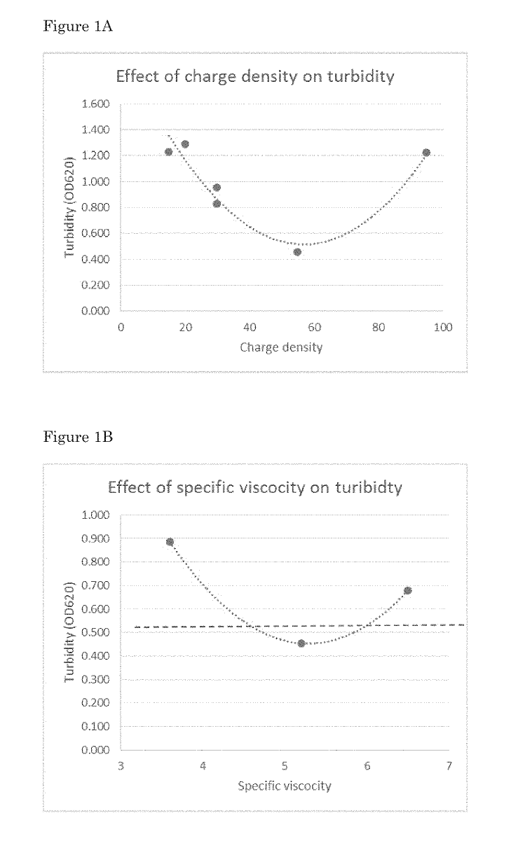

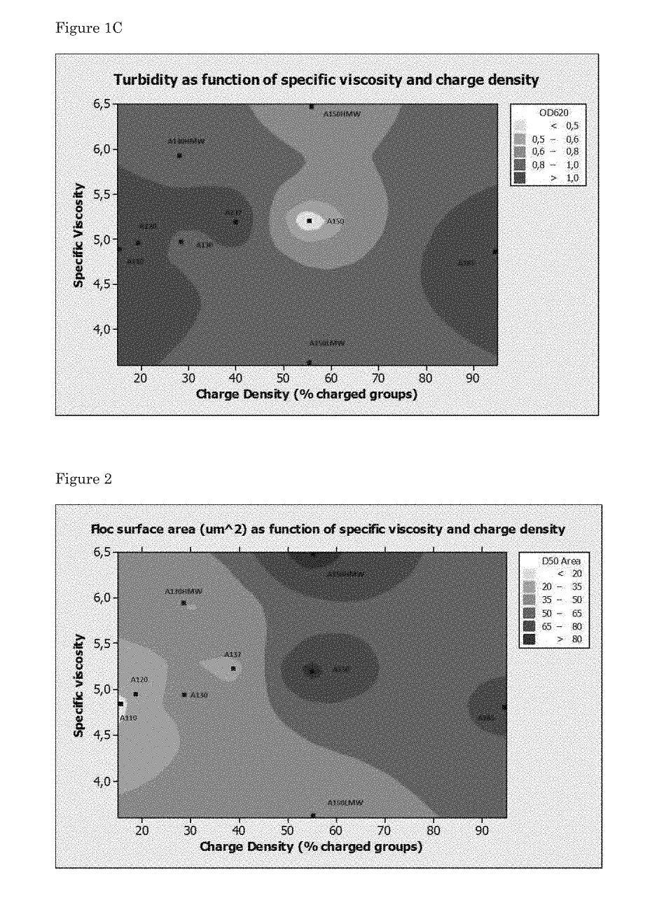

A series of over 200 experiments with different anionic polyacrylamides as well as other flocculants and different coagulants was tested as described above. These flocculants include a variety of common alternatives to polyacrylamides such as Guar Gum, Xanthan Gum and Chitosan. A representative selection of turbidity and floc sizes were plotted in contour plots (FIGS. 1 and 2).

These data reveal that a “sweet spot” exists in terms of specific viscosity and charge density. The flocculant should be a polyacrylamide with a chain length (as indicated by specific viscosity) of between 4 and 6, preferably between 4.7 and 5.6 and even more preferably between 5.0 and 5.4. Furthermore, charge density should be between 45 and 75%, preferably between 50 and 70%, more preferably between 50 and 60%. Ideally, it is around 55%.

### EXAMPLE 3

### Flocculation of Potato Juice by a Silicate Coagulant and Cationic Polyacrylamide

400 mL of industrial potato juice from AVEBE (Gasselternijveen, The Netherlands) was stirred at 200 rpm in a 1 liter beaker. Several different silicates were added to potato juice samples and allowed to stir for 1 minute. These silicates were Britesorb BK75 Silica (PQ Corporation), Kemira Waterglass ALC201 (Kemira), Rithco SiO₂ (Rithco) and Organo-Floc 475 (Kam Biotechnology Ltd.) Subsequently, 2 mL of a 1 g/L cationic acrylamide solution (“cationic PAM”, C492, Kemira) were added. The juice was allowed to settle for 1 minute, followed by a 1 minute centrifugation step at 2900 g. The supernatants were analysed as in example 1.

TABLE 3
Effect of silicate coagulants and cationic
polyacrylamides on potato juice turbidity

| | | | Particle size |
|---|---|---|---|
| Coagulant | Flocculant | OD620 | D50 |
| Rithco SiO2 | Cationic PAM | 0.683 | 54.72 |
| Waterglass ALC201 | Cationic PAM | 0.194 | 100.86 |
| Organo-Floc 475 | Cationic PAM | 0.428 | 61.51 |
| Britesorb BK75 | Cationic PAM | 1.868 | 10.61 |

The results show that silicate materials function well as coagulants as long as the silicate is polymeric silicate. The ineffective Britesorb BK75 is a non-polymeric silica sol and occurs as small silica particles in solution. The effective Rithco silicate consist of silicate particles modified with cationic polymer chains. The Organo-Floc 475 consists of silicate particles caught in polymerized aluminum salts. Silicates that are chemically associated into larger structures are effective coagulants in potato juice while monomeric silicates are not.

### EXAMPLE 4

### Flocculation of Potato Juice by Helix-Forming Polymers

Flocculation according to method C requires a flocculant that is capable of forming helices in the context of potato juice. Helix-forming flocculants are characterised by being polysaccharides with α1-3 and 1-4 glycosidic bonds. Examples include carrageenan, alginate, cellulose, amylose, gellan gum, xanthan, curlan, agar and agarose. Out of this set only alginates and carrageenan form helices in the context of native potato juice with components that occur natively in the potato, carrageenan with potassium, and alginate with calcium.

However, in practice, flocculation with alginate is sensitive to the age of the potato juice. Alginate does not reduce turbidity without the addition of calcium, but performs well with 10 mM of added calcium in fresh potato juice (table 5).

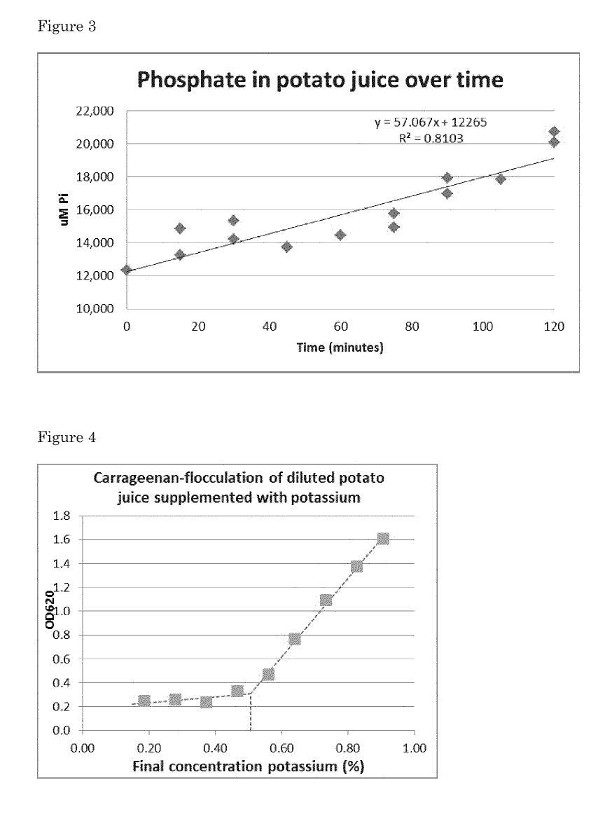

The modest levels of calcium that alginate requires to function are sequestered by phosphate that is released from components in the potato juice over time as the juice ages. (FIG. 3). This can be simulated by adding 10 mM of phosphate to fresh potato juice, which likewise prevents alginate from flocculating.

In ripened potato juice, this calcium is no longer sufficient for alginate flocculation (Table 5). Overdosing the calcium will restore alginate flocculation (Table 5), but high calcium levels lead to scaling problems downstream in the process.

Carrageenan-based flocculation meanwhile remains unaffected by the age of the potato juice, and is therefore preferred over alginate.

Care should be taken in introducing carrageenan into potato juice. The carrageenan undergoes its transition to the helical state at potassium concentrations that are typically lower than those commonly found in potato juice. In effect, potassium is endogenously present at an overdose which causes the carrageenan to flocculate too rapidly, resulting in incomplete inclusion of turbid material. FIG. 4 shows the final turbidity of a potato juice as a function of potassium concentration. Natively, potato juice contains roughly 0.6 wt. % of potassium while for effective flocculation a potassium level of 0.5% or lower is desired.

This issue can be dealt with in three ways:

Firstly, the flocculant can be introduced at a rate of 0.2 volumes of flocculant solution per volume of potato juice per minute, diluting the juice to permissive potassium levels while the long addition time slows down the process.

Secondly, the flocculant can be introduced in combination with a synergistic polymer that does not undergo a helix transition itself, but does contribute to the floc network. Ideally, this synergistic polymer binds to turbid components itself, essentially acting as a coagulant.

Thirdly, a flocculant can be selected that is intrinsically less responsive to potassium. Such flocculants are carrageenans with a partial iota-kappa character or mixtures of iota- and kappa-carrageenans.

Table 4 shows the effect of adding either a kappa-carrageenan such as GP812 or a kappa-carrageenan with partial iota-character such as LB-2700 to potato juice. While GP812 only works in diluted juice, LB-2700 retains its ability to reduce turbidity even without dilution.

TABLE 4
Effect of different approaches for carrageenan-
flocculation in potato juice

| Flocculant | Diluted juice | Synergistic polymer | Less responsive | OD620 |
|---|---|---|---|---|
| GP812 | Yes | Wisprofloc N | — | 0.388 |
| GP812 | No | Wisprofioc N | — | 1.218 |
| LB-2700 | Yes | Wisprofloc N | Yes | 0.179 |
| LB-2700 | No | Wisprofloc N | Yes | 0.244 |

GP812 is a kappa-carrageenan (FMC Biopolymer GP812, 20031021), LB-2700 is kappa-carrageenan with iota-character (Benlacta LB-2700, Shemberg Biotech Corporation,), Wisprofloc N is a neutral pregelatinised potato starch (AVEBE)

Phosphate Determination

Phosphate in potato juice was determined as follows: Potato juice aliquots were dried in glass tubes. 300 μL of 70% perchloric acid (Prolabo 20587.296) were added to oxidize interfering components. The tubes were incubated for 3 hours at 180° C. and cooled to ambient temperature. 1 mL of demiwater, 400 μL of 1.25 wt. % ammonium molybdate (Merck 1.01180) and 400 μL of 5% ascorbic acid (Prolabo 20150.231) were added. The samples were heated for 5 minutes in a boiling waterbath and absorbances were read at 797 nm on a ThermoScientific Multiskan Go and compared to a calibration curve prepared with dihydrogen potassium phosphate (Merck 1.04873).

Potato Juice Flocculation by Alginate and Carrageenan

Flocculation was performed essentially as in example 1. Flocculant/coagulant combinations were 0.4 g/L GP812 κ-Carrageenan (FMC Biopolymer GP812, 20031021)/0.6 g/L Wisprofloc N (AVEBE) and 1 g/L alginate (Manucol DH, 4-8-12, FMC Biopolymer). Turbidities were determined according to example 1.

Diluted Potato Juice Flocculation by Carrageenan at Different Potassium Levels

A fresh potato juice was diluted by mixing 3 volumes of potato juice with 7 volumes of demineralised water. Flocculation was performed in 400 mL aliquots supplemented with potassium from concentrated stock solution, according to example 1. Final turbidities were measured according to example 1 and multiplied by 10/3 to convert them back to the turbidities as they would have occurred in the original juice.

TABLE 5
Effect of aging on alginate flocculation. Both aging the juice
and adding additional phosphate remove the ability of alginate
to flocculate potato juice. Sequestering the phosphate by increasing
the dose of calcium restores alginate flocculation.

| | | mM cal- | mM Phos- | |
|---|---|---|---|---|
| | Age of | cium | phate | |
| Coagulant/Flocculant | juice | added | added | OD620 |
| None, Potato Juice as is | Fresh | 0 | 0 | 1.934 |
| Alginate (Manucol DH) | Fresh | 0 | 0 | 1.687 |
| Wisprofloc N/Carrageenan | Fresh | 0 | 0 | 0.176 |
| GP812 | | | | |
| Alginate (Manucol DH) and | Fresh | 10 | 0 | 0.737 |
| calcium | | | | |
| Alginate (Manucol DH) and | Fresh | 10 | 10 | 1.499 |
| calcium | | | | |
| None, Potato Juice as is | 2 hours | 0 | 0 | 1.713 |
| Wisprofloc N/Carrageenan | 2 hours | 0 | 0 | 0.178 |
| GP812 | | | | |
| Alginate (Manucol DH) and | 2 hours | 10 | 0 | 1.535 |
| calcium | | | | |
| Alginate (Manucol DH) and | 2 hours | 20 | 0 | 0.337 |
| double calcium | | | | |

### EXAMPLE 5

### Flocculation in the Presence of Weighting Agents

Flocculation was performed as in example 1 using the carrageenan system. Weighting agents were added at a level of 1 g/L juice prior to flocculating. The agents used were calcium carbonate (SigmaAldrich 2066) calcium hydrogen phosphate (SigmaAldrich, 04231), metallic iron (SigmaAldrich 12310), ferric oxide (Fe(III)O) (SigmaAldrich529311), ferric oxide (Fe(II,III)O) (SigmaAldrich 310069), ferric phosphate (SigmaAldrich 436011) and kaolin (SigmaAldrich).

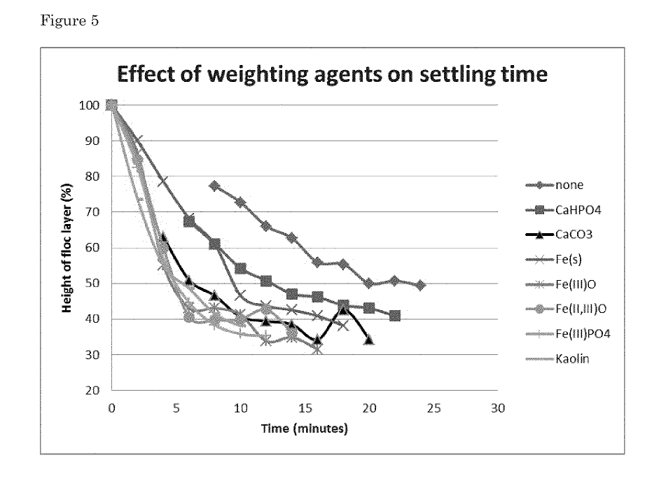

Upon recovering the flocculating solutions from the flocculator, development of the floc material was monitored by taking pictures every 2 minutes. The extent of settling was determined by dividing the top of the floc layer by the height of the liquid in the beaker and expressing this as a percentage. The results were plotted in MS Excel (FIG. 5).

After flocculation, turbidities were determined as per example 1. Densities of the flocs were determined on sucrose density gradients.

Gradients were prepared by mixing 5 mL of a 50% and 70% w:v sucrose solution in artificial potato juice (30 mM citrate pH 6.5 and 100 mM KCl) in a gradient creator that was emptied by a peristaltic pump operating at 10 mL per minute into a clear plastic tube, loaded from the top. These were developed by centrifugation at 2900 g for 10 hours. Densities were determined by observing the migration of the floc in the density gradient.

TABLE 6
Effect of weighting agents on flocculation of potato juice
in terms of final turbidity, floc density and juice colour.

| | | Weighting | | |
|---|---|---|---|---|
| | | agent Density | | Floc |
| Weighting agent | OD620 | (g/cm3) | Colour | density |
| None, Potato Juice as is | 1.628 | | as is | n/a |
| None, flocculated juice | 0.2 | | as is | 1.25 |
| CaHPO4 | 0.218 | 2.929 | as is | 1.26 |
| CaCO3 | 0.176 | 2.71 | as is | 1.26 |
| Fe(s) | 0.203 | 7.87 | darkened | 1.26 |
| Fe(III)O | 0.2 | 5.24 | darkened | 1.28 |
| Fe(II, III)O | 0.142 | 5.24 | as is | >1.35 |
| Fe(III)PO4 | 0.149 | 2.87 | darkened | >1.35 |
| Kaolin | 0.173 | 2.16 | as is | >1.35 |

The addition of weighting agents increases the densities of the flocs and improves their settling rates. The improvement on settling rate was not determined by the density of the agent. However, ferric weighting agents tended to cause oxidation of potato juice phenolics, resulting in a darkening of the juice.

### EXAMPLE 6

### Composition of a Lipid Isolate that is Obtained from Floc Material

Flocs were subjected to organic solvent extraction after which the total lipid contents were determined gravimetrically. The levels of phospholipids were determined according to the method of Rouser (Rouser, G., Fleischer, S. & Yamamoto, A. (1970) Lipids 5, 494-496.) while the level of glycolipids were determined using the Orcinol method. Briefly, 100 μL aliquots of lipids extract were evaporated to dryness in glass tubes. 200 mg orcinol (SigniaAldrich 447420) was dissolved in 100 mL of 70% v:v sulphuric acid (Merck 1.00731). 2 mL of this solution were added to each glass tubes and incubated for 20 minutes at 80° C. After cooling to ambient temperature absorbances were read at 505 nm on a Multiskan Go (Thermo Scientific) and glycolipids levels were determined relative to a calibration curve prepared from glucose (Merck 8337.0250)

TABLE 7

| | Mean | Stdev |
|---|---|---|
| % Lipid in floc | 24.9 | 4.0 |
| % Phospholipid in lipid | 33.3 | 4.0 |
| % Glycolipid in lipid | 12.2 | 1.9 |

The levels of fatty acids in the floc, expressed as the sum of lipid-bound and free fatty acids was determined by an external contract analysis laboratory, and are shown in table 8.

TABLE 8
fatty acid profile of the potato lipid material
after extraction from the floc material.

| Fatty acid | % |
|---|---|
| Palmitic acid C16:0 | 23 |
| Palmitoleic acid C16:1n7 | trace |
| Stearic acid C18:0 | 6 |
| Oleic acid C18:1n9 | 2 |
| Linoleic acid C18:2n6 | 41 |
| Linolenic acid C18:3n3 | 20 |
| Arachidic acid C20:0 | 2 |
| Other | 6 |
| Total | 100 |

In addition, lutein was found at levels between 30-75 mg/kg lipid material. Furthermore, the presence of α-tocopherol, and the carotenoid esters Zeaxanthin, Violaxanthin, Neoxanthin, α-Carotene and Neurosporene was demonstrated. The presence of carotenoids at these levels in the lipid isolate resulted in a distinct yellow appearance.

Detection of tocopherol and other carotenoid esters can be performed by the HPLC-method of Morris et al (Journal of Experimental Botany, 2004, 55, p 975-982 “Carotenogenesis during tuber development and storage in potato”).

### EXAMPLE 7

### Extraction and Characterization of the Amino Acid Material

Potato juice was flocculated using the polytannine Bio20 (Servyeco as the coagulant and an acrylamide with a charge density of 55% and a specific viscosity of 5.2 as the flocculant. In addition, κ-carrageenan was added together with the polytannine. The floc material was isolated by sedimentation.

The isolated floc material was dewatered by filtration and extracted with an equal weight of demineralized water for one hour by automated shaking in a tube and allowing the sediment to settle. The aqueous extract was subjected to amino acid analysis using HPLC-UV/FLU and/or Biochrom amino acid analysers using classical ion-exchange liquid chromatography with post-column Ninhydrin derivatisation and photometric detection. As a control, free amino acids from unflocculated potato juice (“PFJ”) were analyzed using the same methodology. The results can be seen in table 9.

TABLE 9
amino acid profile of the amino acid material extracted
from floc material, compared to the amino acid profile
of the free amino acids in non-flocculated potato juice,
in g/kg free amino acids, and wt. %.

| | PFJ | PFJ | floc | floc | increase |
|---|---|---|---|---|---|
| | [g/kg] | % | [g/kg] | % | factor |
| Alanine | 0.06 | 2.3 | 0.43 | 19.6 | 8.6 |
| Asparagine | 0.99 | 37.5 | 0.58 | 26.5 | 0.7 |
| Aspartic acid | 0.22 | 8.3 | 0.01 | 0.5 | 0.05 |
| Glutamine | 0.43 | 16.3 | 0.25 | 11.4 | 0.7 |
| Glutamic acid | 0.08 | 3.0 | 0.07 | 3.2 | 1.05 |
| Glycine | 0.01 | 0.4 | 0.03 | 1.4 | 3.6 |
| Isoleucine | 0.05 | 1.9 | 0.07 | 3.2 | 1.7 |
| Leucine | 0.06 | 2.3 | 0.1 | 4.6 | 2 |
| Lysine | 0.07 | 2.7 | 0.12 | 5.5 | 2.06 |
| Serine | 0.1 | 3.8 | 0.09 | 4.1 | 1.08 |
| Valine | 0.11 | 4.2 | 0.13 | 5.9 | 1.4 |
| total free amino | 2.64 | | 2.19 | | |
| acids | | | | | |

In table 9, the total of free amino acids was compared to the quantities of particular amino acids in absolute and relative numbers. The increase factor is calculated as the increase in relative presence in the floc, relative to the presence in potato juice (increase factor=floc %/PFJ %).

1. A method of clarifying root or tuber juice, comprising contacting a root or tuber juice with a coagulant and a flocculant to form a floc material, wherein
a) the coagulant comprises a cationic coagulant and the flocculant comprises an anionic polyacrylamide with a specific viscosity of 4-6 mPa·s and a charge density between 45 and 75%; or
b) the coagulant comprises a polymeric silicate of formula SiO₃²⁻ and the flocculant comprises a cationic polyacrylamide with a specific viscosity of 3-5 mPa·s and a charge density of at most 30%; or
c) the coagulant comprises a cationic or neutral coagulant and the flocculant comprises carrageenan;
and wherein the floc material is subsequently isolated from the juice to obtain a clarified root or tuber juice and a floc material.

2. A method according to claim 1, wherein the molecular weight of the polyacrylamide is between 1 and 20·10⁶ Da.

3. A method according to claim 1, wherein the cationic coagulant comprises an epiamine, a polytannine or a polyethylene imine, and wherein the neutral coagulant comprises starch, amylopectin and/or κ-, τ- and/or λ-carrageenan.

4. A method according to claim 1, wherein the carrageenan comprises κ-carrageenan.

5. A method according to claim 1, wherein a surfactant is present during the formation of the floc material.

6. A method according to claim 1, wherein the density of the floc material is increased by inclusion of weighting agents in the floc material.

7. A method according to claim 1, wherein isolation of the floc material is achieved by filtration, sedimentation, centrifugation, cycloning, heat fractionation and/or adsorption.

8. A method according to claim 1, wherein the isolated floc material is subjected to lipid extraction to obtain a lipid isolate.

9. A method according to claim 8, wherein lipid extraction is achieved through organic solvent extraction or supercritical gas extraction, phase separation, freeze-crystallization, pressing, microwave hydrodiffusion, or washing away the non-lipid components.

10. A method according to claim 1, wherein the floc material is subjected to aqueous extraction to obtain an amino acid material.

11. A root or tuber juice, obtainable by a method according to claim 1, comprising at least 0.5 wt. % of dissolved protein, wherein the protein is native and wherein the clarity, expressed as OD620, is less than 0.8.

12. A floc material, obtainable by a method according to claim 1, comprising insoluble particles from root or tuber, and optionally one or more weighting agents and/or surfactants, and further comprising
a) a cationic coagulant and an anionic polyacrylamide with a specific viscosity of 4-6 mPa·s and a charge density between 45 and 75%; or
b) a polymeric silicate of formula SiO₃²⁻ and a cationic polyacrylamide with a specific viscosity of 3-5 mPa·s and a charge density of at most 30%; or
c) a cationic coagulant and carrageenan;
wherein the floc material comprises flocs with a particle size, expressed as surface area of the median of the particle population, of at least 50 μm².

13. A floc material according to claim 12, wherein the material comprises 18-38% lipids.

14. A floc material according to claim 12, wherein the material has a density of at least 1.23 g/cm³.

15. A floc material according to claim 12 for use as a feed material or as a food ingredient.

16. The use of a floc material according to claim 12 as a feed material or as a food ingredient.

17. A lipid isolate, obtainable by the process of claim 8, comprising at least 2 wt. % arachidic acid, lutein at levels between 30-75 mg/kg lipid isolate and tocopherol.

18. A root or tuber derived amino acid material obtainable by the method of claim 10, comprising, as a wt. % of free amino acids:
10-25% alanine
15-35% asparagine
5-16% glutamine
5-9% valine
0.1-3.5% glutamic acid
0.5-10% glycine

19. A taste enhancer or a food supplement comprising an amino acid material according to claim 18.
